(19) United States
(12) Patent Application Publication
(10) Pub. No.: US 2024/0426520 A1
(43) Pub. Date: Dec. 26, 2024

(54) SOLAR PANEL SERVICE VEHICLE MOVEMENT RESTRICTION DEVICE AND METHOD

(71) Applicants: Ilan LIFSHITZ, Tortola (VG); EVERMORE UNITED S.A., Tortola (VG)

(72) Inventor: Ilan LIFSHITZ, Tortola (VG)

(73) Assignee: EVERMORE UNITED S.A., Tortola (VG)

(21) Appl. No.: 18/701,377

(22) PCT Filed: Oct. 14, 2022
(86) PCT No.: PCT/IL2022/051091

§ 371 Date: Apr. 15, 2024

Related U.S. Application Data
(60) Provisional application No. 63/379,292, filed on Oct. 13, 2022.
(60) Provisional application No. 63/255,981, filed on Oct. 15, 2021.

(51) Int. Cl. F24S 40/20; B60B 15/00; F24S 40/90; H02S 40/10

(52) U.S. Cl. CPC F24S 40/20; B60B 15/00; B60B 2900/112; B60B 2900/115; F24S 40/90; H02S 40/10

(57) ABSTRACT

A passive securing device is provided for restricting movement of a solar panel service vehicle (SPSV), the passive securing device including a barrier portion, a restorative element and a mechanical limiter. The SPSV includes at least one motorized wheel, having an abrasive surface, for securing the SPSV moving over a platform into a predetermined area. The mechanical limiter prevents upwards movement of the SPSV from the platform when the SPSV is in the predetermined area. The barrier portion in a far edge position and the restorative element in a relaxed position prevents the SPSV from passively exiting the predetermined area. When the motorized wheel is actively rotated into the barrier portion, the abrasive surface forces the restorative element into a compressed position, thereby moving the barrier portion into a near edge position and enabling the SPSV to leave the predetermined area.

### FIELD OF THE DISCLOSED TECHNIQUE

The disclosed technique relates to devices and methods for restricting the movement of solar panel service vehicles in general, and to methods and devices for securing the movement of solar panel service vehicles while inoperative to a restricted area, in particular.

### BACKGROUND OF THE DISCLOSED TECHNIQUE

Solar panels are known in the art. They are placed outdoors typically either in fields or on rooftops. Being located outdoors, they are subjected to wind, dust, rain, snow and other weather oriented phenomena. As a result, the surface of a solar panel may become dirty, thereby reducing the amount of light reaching the photo-reactive elements (e.g., photovoltaic cells or conduits of fluid to be heated). Solar panel cleaning systems are also know in the art, and typically include an automated/robotic cleaning mechanism that travels along the solar panel configuration and cleans the solar panel surface from dirt attached thereto, thereby allowing more light to reach the photo-reactive elements.

Known in the art are various cleaning mechanisms that can be placed directly on the solar panel surface and which can travel “freely” thereupon. In many of these cases, an extraneous panel docking area may be provided for various purposes, such as battery charging and/or maintenance of the cleaning mechanism. Alternatively, a cleaning mechanism can be confined to a pre-installed track or rail, either defined by the structure (e.g., the edges) of the solar panels or pre-installed along a row or cluster of solar panels. Solar panel cleaning mechanisms typically travel using motorized wheels that engage (using friction oriented forces) with either the track or solar panel surface that these wheels come in contact with, depending on the friction coefficient and the normal force (i.e., respective of the track or surface) applied by the wheel. Being located outdoors too, such cleaning mechanisms are subject to winds and prone to movement thereby. In some areas and under certain conditions, these winds can reach very high speeds that are able to overcome the friction oriented forces and cause the wheel units of such cleaning mechanisms to skid, which may cause damage to the cleaning mechanisms themselves and also to the solar panel.

Devices for securing a solar panel cleaning mechanism in position are known in the art and usually include securing mechanisms to lock and securely hold the cleaning mechanism in a particular place. These securing mechanisms are typically electrically operated and are further controlled to hold or release the solar panel cleaning mechanism upon command. The electrical operation of such securing mechanisms adds not only a cost to such devices but also increases the complexity of these securing mechanisms, including the possibility for electrical malfunction. What is needed is a securing mechanism which is more cost effective and not prone to electrical malfunctions.

### SUMMARY OF THE PRESENT DISCLOSED TECHNIQUE

It is an object of the disclosed technique to provide a novel method and system for a securing device for restricting the movement of a solar panel service vehicle. In accordance with the disclosed technique, there is thus provided a passive securing device for a solar panel service vehicle including a barrier portion, a restorative element and a mechanical limiter. The solar panel service vehicle includes at least one motorized wheel, having an abrasive surface, for securing the solar panel service vehicle moving over a platform into a predetermined area. The restorative element is coupled with the barrier portion. The barrier portion is configured to move between a near edge position and a far edge position relative to the platform and the restorative element has a relaxed position and a compressed position. In the relaxed position of the restorative element, the barrier portion is in the far edge position and in the compressed position of the restorative element, the barrier portion is in the near edge position. The restorative element is in the relaxed position when no external force is applied to it. The mechanical limiter is for preventing upwards movement of the solar panel service vehicle from the platform when the solar panel service vehicle is in the predetermined area. The barrier portion in the far edge position prevents the solar panel service vehicle from passively exiting the predetermined area. When the motorized wheel is actively rotated into the barrier portion, the abrasive surface forces the restorative element into the compressed position, thereby causing the barrier portion into the near edge position and enabling the solar panel service vehicle to leave the predetermined area. In the far edge position, a distal end of the barrier portion engaging with the motorized wheel of the solar panel service vehicle is raised to a height not greater than ⅗ of a diameter of the motorized wheel.

### BRIEF DESCRIPTION OF THE DRAWINGS

The disclosed technique will be understood and appreciated more fully from the following detailed description taken in conjunction with the drawings in which:

FIGS. 1A-1H are side view schematic illustrations of a solar panel cleaning mechanism securing device, constructed and operative in accordance with an embodiment of the disclosed technique;

FIGS. 2A-2C are side view schematic illustrations of an embodiment of a solar panel cleaning mechanism on a solar panel and positioned in a solar panel cleaning mechanism securing device, constructed and operative in accordance with another embodiment of the disclosed technique;

FIG. 3 is a schematic side view illustration of a mechanical limiter for preventing a solar panel cleaning mechanism from exiting a securing device due to wind gusts, constructed and operative in accordance with a further embodiment of the disclosed technique;

FIG. 4 is a schematic side view illustration of a barrier of a securing device at different end positions, constructed and operative in accordance with another embodiment of the disclosed technique;

FIG. 5A is a side view schematic illustration of another solar panel cleaning mechanism securing device similar to FIG. 1A which does not use a spring, constructed and operative in accordance with a further embodiment of the disclosed technique;

FIG. 5B is a side view schematic illustration of a further solar panel cleaning mechanism securing device similar to FIG. 1A which also does not use a spring, constructed and operative in accordance with another embodiment of the disclosed technique; and

FIG. 5C is a side view schematic illustration of another solar panel cleaning mechanism securing device similar to FIG. 1A which does not use a stopper, constructed and operative in accordance with a further embodiment of the disclosed technique.

### DETAILED DESCRIPTION OF THE EMBODIMENTS

The disclosed technique overcomes the disadvantages of the prior art by providing a device and method for passively securing the wheels of a solar panel cleaning mechanism in a service area and for preventing the solar panel cleaning mechanism from moving towards the solar panels themselves when it is inoperative (i.e., when no power is provided to it in order to turn the wheels of the solar panel cleaning mechanism). A solar panel cleaning mechanism securing device according to the disclosed technique is completely passive electrically and does not require any power or electromotive force provided thereto to operate. In addition, no external control of any kind is required to operate the securing device, whether for securing the solar panel cleaning mechanism after a cleaning run or for releasing the cleaning mechanism to clean solar panels. The securing device of the disclosed technique is such that it is immune to external forces like the wind and will retain a solar panel cleaning mechanism locked in its secure area side. According to the disclosed technique, the solar panel cleaning mechanism will only leave the secure area side when the solar panel cleaning mechanism activates its drive wheels and actively rotates out of the securing device. Otherwise, passive forces will not enable the solar panel cleaning mechanism to exit the securing device.

The solar panel cleaning mechanism securing device according to the disclosed technique comprises of a stop panel that rises from the surface towards the secure area that operates according to the following mechanical principals:
The solar panel cleaning mechanism securing device resists a non-spinning wheel arriving from the secure area towards the solar panel, thereby blocking it from passing over towards the solar panel;
The solar panel cleaning mechanism securing device yields down to a wheel rolling from the solar panel towards the secure area;
The solar panel cleaning mechanism securing device yields down to a wheel rolling (i.e., a driving wheel) and in a sense, climbing over it, moving from the secure area towards the solar panel, thereby enabling movement of the solar panel cleaning mechanism securing device towards the solar panel; and
The driving wheel must have a plurality of teeth or any other type of external surface which is abrasive and can grip the solar panel cleaning mechanism securing device in order to rotate it downwards and climb over the securing device as the driving wheel rotates. The abrasive external surface can also be embodied as a flexible material.

According to the disclosed technique, the securing device also includes a mechanical limiter which prevents upward movement of a solar panel cleaning mechanism which is positioned within the securing device. As described below, wind gusts over a solar park can cause a solar panel cleaning mechanism to passively exit the securing device by moving the driving wheel upwards enough to rotate a barrier of the securing device downward. In order to prevent such passive releases of the solar panel cleaning mechanism, a mechanical limiter is included in the securing device of the disclosed technique in order to prevent upward movement of the solar panel cleaning mechanism when positioned in the securing device.

The solar panel cleaning mechanism securing device is described herein as being situated at the end of a solar panel row where a solar panel cleaning mechanism may dock and park. The disclosed technique however is not limited to such a positioning of the securing device. According to the disclosed technique, the solar panel cleaning mechanism securing device can be positioned in a standalone docking port or bay which may be positioned at a distance from a solar panel row, such that there is a gap between the end of the solar panel row and the docking port or bay. The solar panel cleaning mechanism securing device can also be positioned in the middle of a solar panel row and does not need to necessarily be positioned at the end of a solar panel row, for example in a resting position for the solar panel cleaning mechanism between adjacent sets of solar panels on a single solar panel row. In a further embodiment, the solar panel cleaning mechanism securing device can be installed on a transporter for moving the solar panel cleaning mechanism from one solar panel row to another solar panel row. In this embodiment, the transporter can be embodied as any kind of vehicle and/or equipment capable of moving the solar panel cleaning mechanism from solar panel row to solar panel row.

It is noted as well that the disclosed technique is described with reference to a solar panel cleaning mechanism however the disclosed technique can equally be applied to and embodied for use with any kind of solar panel service vehicle, meaning a device capable of travelling over solar panels for various purposes. For example, a solar panel service vehicle can include solar panel cleaning mechanisms, robots and vehicles, solar panel vehicles for testing and verifying solar panels, solar panel vehicles for swapping defective solar panels with new solar panels, solar panel vehicles for testing the performance of solar panels, and the like. Thus the disclosed technique is not limited to solar panel cleaning mechanisms. In addition, according to the disclosed technique, the solar panel cleaning mechanism securing device can be located on a vehicle for transporting at least one solar panel service vehicle from solar panel row to solar panel row.

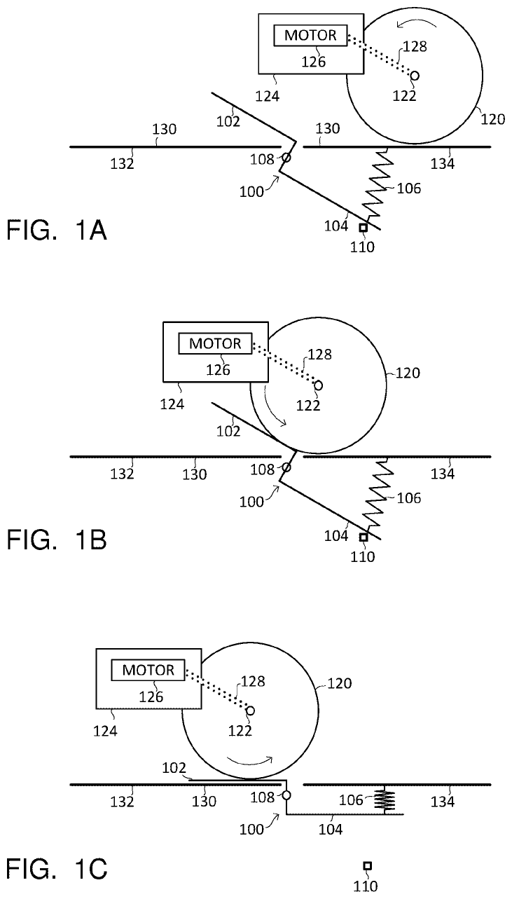

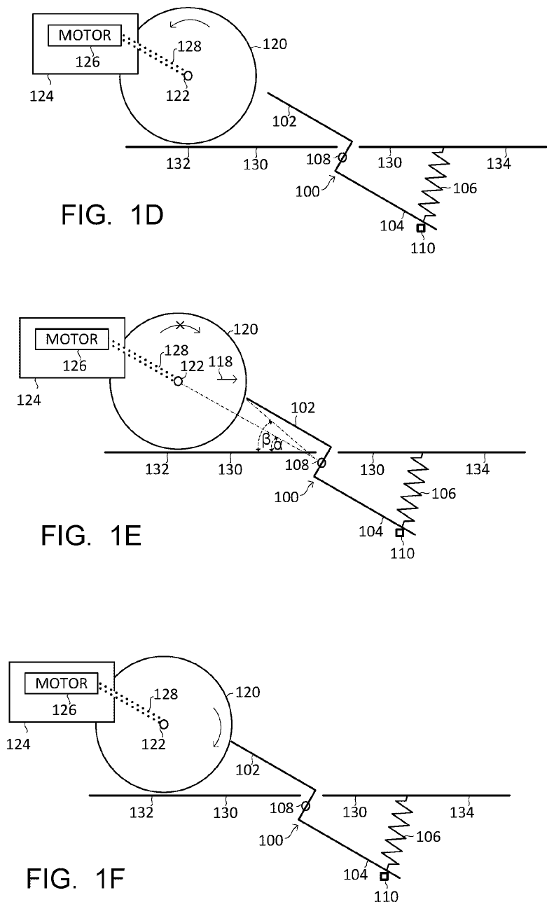

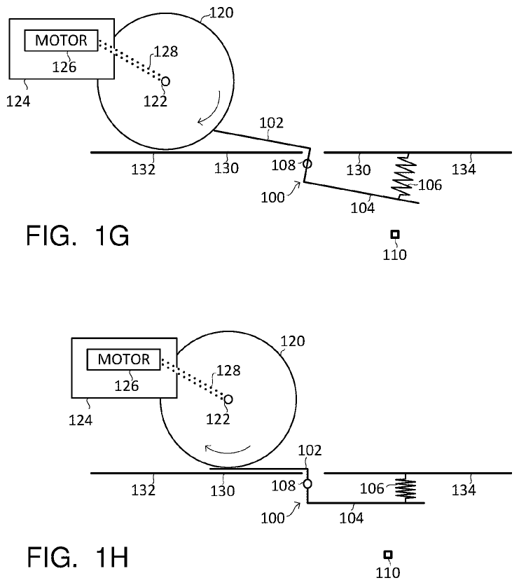

Reference is now made to FIGS. 1A-1H, which are side view schematic illustrations of a solar panel cleaning mechanism securing device, generally referenced 100, constructed and operative in accordance with an embodiment of the disclosed technique. Securing device 100 is mounted on a platform 130 extending between the secure area side 132 and the solar panel side 134 and a wheel of a solar panel cleaning mechanism generally referenced 120. Wheel 120 forms part of a solar panel cleaner 124 (shown only schematically as a box). It is noted that platform 130 is simply a pathway on which wheel 120 can move under certain conditions, between secure area side 132 and solar panel side 134 and as such is defined by secure area side 132 and solar panel side 134. Platform 130 may be made from a material such as metal or plastic. Platform 130 in FIGS. 1A-1H is merely schematic and can represent a surface or a profile over which solar panel cleaner 124 can dock and park. Platform 130 can be an extension of a solar panel row or may be situated on a vehicle for transporting solar panel cleaner 124 from solar row to solar row.

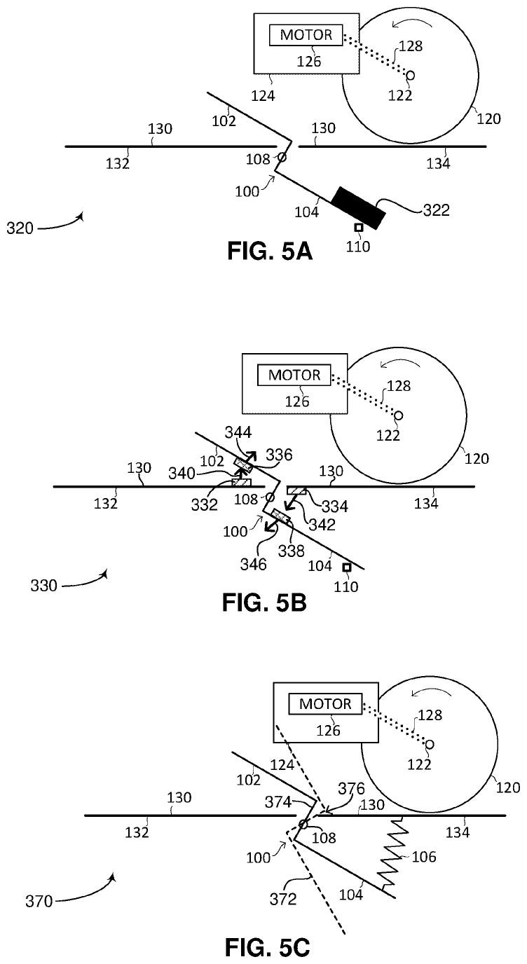

Securing device 100 includes a barrier portion 102, coupled with a reference portion 104 via a hinge 108. Securing device 100 further includes a spring 106 coupled between reference portion 104 and solar panel side 134. Securing device 100 further includes a stop 110, located underneath reference portion 104, for preventing reference portion 104 from tilting further downward, thereby also preventing barrier portion 102 from tilting upward beyond a certain point (not shown). It is noted that stop 110 can be positioned in other positions for preventing reference portion 104 and/or barrier portion 102 from moving beyond its desired angle. For example, the stop can be located on the upper side (not shown) of platform 130 or on the platform itself (as described below in FIG. 5C).

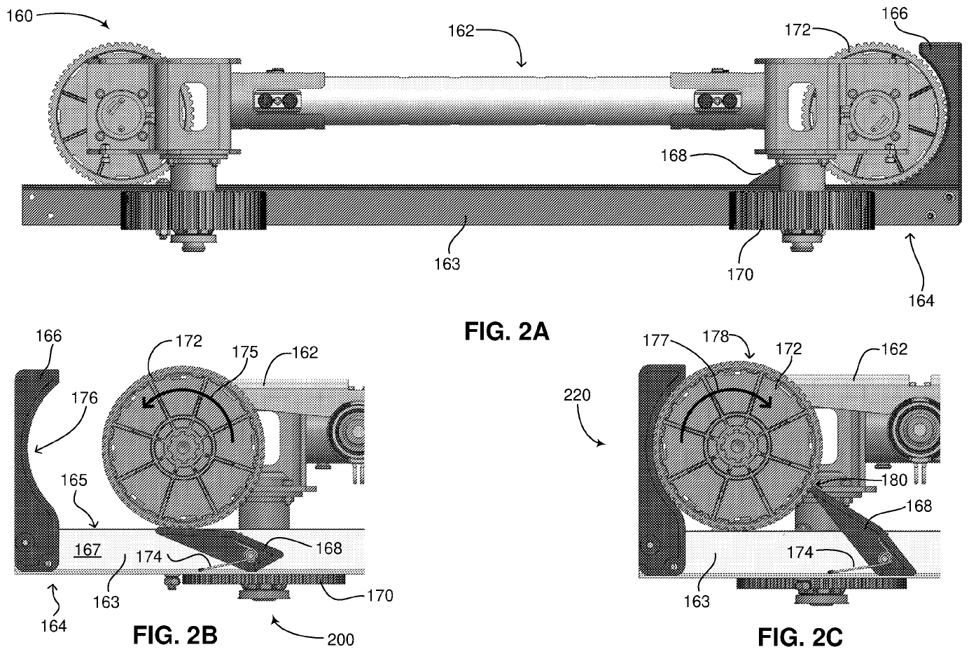

The purpose of this arrangement of the disclosed technique is to enable barrier portion 102 to tilt upward, but not beyond a certain point, while also enabling it to tilt downward towards platform 130, when sufficient external force is applied. Accordingly, other configurations based on the same principles are available and possible. For example, spring 106 can be coupled between reference portion 104 and any adequate anchoring point, not necessarily located on platform 130. Alternatively, another spring (not shown) similar to spring 106 can be adapted to be coupled directly with barrier portion 102, forcing it upward. In general, stop 110 is positioned such that even in its relaxed and expanded position, spring 106 is under slight tension and exerts a relatively small restorative force. Alternatively, an axial spring (not shown) can be incorporated with hinge 108, either internally or externally, an example of which is shown below in FIGS. 2B and 4. In such embodiments, the securing device does not include a reference portion 104, having barrier portion 102 being located within the profile of a docking station and the spring being located along the axis of the profile. With an axial spring, a reference element (such as stop 110) becomes optional, because the barrier element (such as barrier portion 102) is in practice coupled directly to the hinge-spring assembly. Spring 106 is a mechanical coiled spring, however, it can be replaced by any shape memory elastic module of any kind (e.g., hydraulic) that aspires to return to its relaxed configuration when forced away from it. Thus spring 106 can be embodied as a push spring, a torsion spring and other kinds of springs. According to a further embodiment of the disclosed technique, a rotational stop can be incorporated into hinge 108, preventing it from rotating clockwise beyond a certain angle.

As mentioned above, a solar panel cleaning mechanism wheel 120 is also shown in FIGS. 1A-1H. This wheel is coupled with a motor 126 which may turn the wheel clockwise or counterclockwise about its axis 122, thereby causing it to roll to the right or to the left of platform 130. It is noted that optionally, wheel 120 may be coupled with motor 126 via a transmission module 128, typically with a gear down ratio, thereby reducing the rotation speed of the motor and increasing the torque applied to wheel 120 at its wheel axis 122. Alternatively, motor 126 can be configured by design, to directly turn wheel 120 at desired speeds and torque values. In FIGS. 1A-1H, both barrier portion 102 and reference portion 104 are shown from the side and hence their width is not visible from that perspective. It is noted that the width of either one of barrier portion 102 and reference portion 104 can be smaller, equal to or greater than the width of wheel 120 (width not shown).

With reference to FIG. 1A, since no external pressure is applied to barrier portion 102, spring 106 is in a relaxed state and at a given length for that relaxed state, it positions reference portion 104 at an angle from platform 130. Since reference portion 104 is firmly coupled with barrier portion 102, barrier portion 102 is also positioned at an angle from platform 130. It is noted that these angles can be identical if barrier portion 102 and reference portion 104 are parallel to each other. As can be seen from FIG. 1A, wheel 120 is rotated counterclockwise, thereby rolling to the left, towards secure area side 132.

With reference to FIG. 1B, wheel 120 continues rolling to the left and approaches barrier portion 102. Further movement thereof will place wheel 120 on barrier portion 102, thereby applying down pressure on barrier portion 102. With reference to FIG. 1C, wheel 120 rolls on barrier portion 102, applying down pressure on barrier portion 102 and forcing it to rotate counterclockwise towards platform 130. Barrier portion 102 thus conforms with the angle at which platform 130 is positioned at. As barrier portion 102 rotates counterclockwise, so does reference portion 104, thereby applying pressure on spring 106, and thus causing it to compress and resist.

With reference to FIG. 1D, wheel 120 has rolled to the left, beyond barrier portion 102 and no longer applies any force to barrier portion 102. As a result, nothing resists spring 106, which as a result extends from its compressed state back to its relaxed state, thereby causing the a clockwise rotation of barrier portion 102 to return to being at an angle relative to platform 130. It is noted that after passing into secure area side 132, the rotation of wheel 120 may be stopped by a physical stop (not shown) located on platform 130. Alternatively, the rotation of wheel 120 may be stopped by other indications such as a drive distance measurement of wheel 120 (for example using encoders to count the number of rotations of wheel 120) or a sensor indication (such as an infrared sensor in the secure area side) that wheel 120 (and thus the solar panel cleaning mechanism) has entered the secure area side.

With reference to FIG. 1E, at this point, the motor 126 ceases to apply rotational force to wheel 120 and from this point on, passively resists the rotation of wheel 120, as depicted by the ‘X’ marked over the curved arrow, on the top portion of wheel 120, indicating that wheel 120 is not turning. Wind gusts may push wheel 120 to the right, indicated by arrow 118 and wheel 120 can skid or rotate slightly to the right up until the point where it comes in contact with barrier portion 102.

Shown in FIG. 1E is a line extending between wheel axis 122 and the center of hinge 108, which is at an angle a relative to platform 130. Also shown is a line extending between the left side tip of barrier portion 102 and angle the center of hinge 108, which is at an angle β. When wheel 120 skids to the right and meets barrier portion 102, angle β should be greater than angle α, so that the pushing force that wheel 120 applies to barrier portion 102 is a rotational force in a clockwise direction, thereby causing reference portion 104 to rotate clockwise until it meets stop 110. Stop 110 prevents reference portion 104 and barrier portion 102 from further rotating clockwise thereby stopping wheel 120 from further movement to the right. Thus by ensuring that angle β is greater than angle α, wheel 120 will remain passively locked in secure area side 132 even if strong gusts of winds push wheel towards barrier portion 102. Conversely, if angle β would be less than angle a, then gusts of wind pushing wheel 120 into barrier portion 120 would push barrier portion 102 down in a counterclockwise direction, thereby freeing wheel 120 from secure area side 132. At this point as long as wheel 120 and solar panel cleaner 124 which is attached thereto are located within secure area side 132, they are restricted from exiting towards solar panel side 134.

In one embodiment of the disclosed technique, the distal end of barrier portion 102 which engages with wheel 120 is raised to a height, shown via angle β, that it not greater than the radius (not labeled) of wheel 120. In this embodiment, the length of barrier portion 102 may be substantially similar to the radius of wheel 120. In another embodiment of the disclosed technique, the length of barrier portion 102 might be significantly longer than the radius of wheel 120 while nonetheless the distal end of barrier portion 120 is not raised to a height greater than the radius of wheel 120. In this embodiment, securing device 100 may allow for easier exiting of wheel 120 from secure area side 132. In a further embodiment of the disclosed technique, the maximum height of the distal end of barrier portion 102 vis-à-vis the radius of wheel 120 can be determined according to a plurality of parameters, such as the size of the teeth (not shown) of wheel 120. the ease at which a solar panel cleaning mechanism can exit from the securing device, the amount of grip of wheel 120, the strength of motor 126 and more. In another embodiment according to the disclosed technique, the maximum height the distal end of barrier portion 102 can be raised to is optionally ⅗ the diameter of wheel 120. Provided wheel 120 has a plurality of teeth or at least an abrasive surface which can catch and grip the distal end of barrier portion 120, even at a height of ⅗ the diameter of wheel 120, rotating wheel 120 in a clockwise direction will grip the distal end of barrier portion 120 and rotate it downward such that wheel 120 can exit secure area side 132. In such an embodiment, there should be a gap between wheel 120 and barrier portion 102 (not as shown in FIG. 1E), an increase in the flexibility of 120 wheel or both, to allow for the downward rotation of barrier portion 102. Given the aforementioned gap, this embodiment may lead to more vibrations of solar panel cleaner 124 (which may rock back and forth in the secure area side due to the gap).

With reference to FIG. 1F, when is it desired that solar panel cleaner 124 moves to solar panel side 134, motor 126 rotates wheel 120 clockwise, as indicated by the clockwise curved arrow denoted on wheel 120. As a result of its clockwise rotation, the outer surface of wheel 120 applies sufficient friction to the edge of barrier portion 102 which is sufficient to overcome the restoring force of spring 106.

With reference to FIG. 1G, the downwards force of friction applied by wheel 120 to the edge of barrier portion 102 rotates barrier portion 102 and reference portion 104 counterclockwise, thereby compressing spring 106. With reference to FIG. 1H, the continual rotation of wheel 120 causes barrier portion 102 to rotate clockwise sufficiently to a point where wheel 120 can roll over it towards solar panel side 134, thereby conveying solar panel cleaner 124 in that direction and releasing the solar panel cleaner from secure area side 132. The disclosed technique thus enables wheel 120 and the solar panel cleaner attached to it to remain passively locked in a secure area side of a platform. Actively rotating wheel 120 towards securing device 100 will release wheel 120 from the secure area side, however passively rotating wheel 120 (from wind gusts, for example) will not. As can be seen, barrier portion 102 in general rotates between a near edge position (which can be completely flush with platform 130 or near platform 130, for example as shown in FIG. 4 below) and a far edge position, when barrier portion 102 is either securing wheel 120 in secure area side 132 or when barrier portion 102 is in its relaxed state (as shown in FIG. 1A).

Reference is now made to FIGS. 2A-2C, which are side view schematic illustrations of an embodiment of a solar panel cleaning mechanism on a solar panel and positioned in a solar panel cleaning mechanism securing device, generally referenced 160, 200 and 220 respectively, constructed and operative in accordance with another embodiment of the disclosed technique. Identical elements in FIGS. 2A-2C are labeled using the same reference numbers. With reference to FIG. 2A, shown is a solar panel cleaning mechanism 162 on a solar panel 163 and positioned in a solar panel cleaning mechanism securing device 164. Details of the various components of solar panel cleaning mechanism 162 are not labeled as solar panel cleaning mechanism 162 can be embodied having many different forms and shapes. Shown in solar panel cleaning mechanism 162 however is a horizontal wheel 170 and a vertical wheel 172. Horizontal wheel 170 is positioned along the side surface of solar panel 163 and rolls along the side surface, keeping solar panel cleaning mechanism 162 aligned with solar panel 163. Horizontal wheel 170 can be embodied as a passive wheel which is not mechanized. Alternatively, horizontal wheel 170 can be embodied as an active wheel which is coupled with a motor (not shown) for driving solar panel cleaning mechanism 162 along solar panel 163. Vertical wheel 172 is coupled with a motor (not shown) and actively drives solar panel cleaning mechanism 162 over the surface of solar panel 163. As described above, the active rotation of vertical wheel 172 allows a solar panel cleaning device (such as solar panel cleaning mechanism 162) to exit a secure area side. As shown, solar panel cleaning mechanism securing device 164 includes a barrier 168 and a bay portion 166. Barrier 168 is an embodiment of barrier portion 102 (FIG. 1D) and substantially prevents vertical wheel 172 from exiting securing device 164 unless vertical wheel 172 is actively driven to rotate. Bay portion 166 holds vertical wheel 172 in place and substantially prevents solar panel cleaning mechanism 162 from rolling off an end of solar panel 163. As shown in FIG. 2A, unlike securing device 100 (FIG. 1A), barrier 168 does not need to be embodied as having a barrier portion 102 (FIG. 1A) above the surface of a solar panel and a reference portion 104 (FIG. 1A) below the surface of the solar panel (and also below the profile holding the solar panel, as shown above in FIGS. 1A-1H) and can be embodied as only having a portion above the surface of the solar panel which rotates into (and thus folds into) the profile of the solar panel. FIG. 2A shows the securing device at the end of a solar panel row however the securing device could also be placed on a transporter for transporting solar panel cleaning mechanism 162 from solar panel row to solar panel row. In such an embodiment, bay portion 166 holds vertical wheel 172 in place and substantially prevents solar panel cleaning mechanism 162 from rolling off an end of the transporter. Bay portion 166 thus keeps vertical wheel 172 from moving in a distal direction from barrier 168.

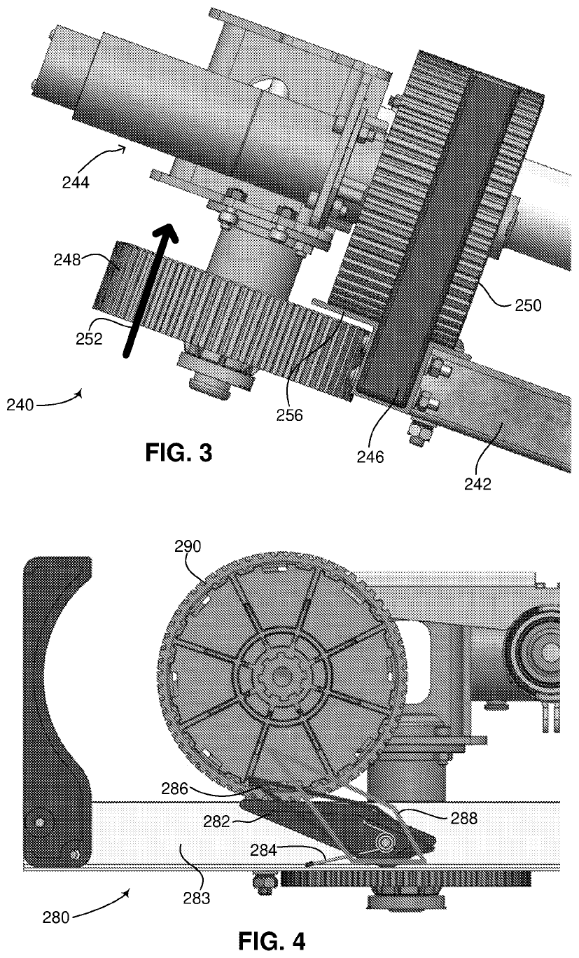

With reference to FIG. 2B, solar panel cleaning mechanism 162 is shown entering the secure area side of barrier 168. As shown, barrier 168 can include a spring 174, enabling barrier 168 to rotate such that it is flush with an upper surface 165 of solar panel 163. As vertical wheel 172 rotates in the direction of an arrow 175, it can rotate barrier 168 towards the upper surface of solar panel 163 in order to enter securing device 164. As shown, barrier 168 rotates into a profile 167 of a docking station of solar panel 163. However, barrier 168 can also be located outside of profile 167. Shown more clearly is a curved shape 176 of bay portion 166, which has a curvature that is substantially similar to the curvature of vertical wheel 172. It is noted however that bay portion 166 as shown is only an example and that other shapes are possible. Bay portion 166 does not need to be curved and can be straight or at an angle (both not shown). In addition, bay portion 166 does not need to be the height of vertical wheel 172 and can be as short as half the height of vertical wheel 172 while nonetheless securely maintaining vertical wheel 172 therein. As described below in FIG. 3, the securing device of the disclosed technique also includes a mechanical limiter (not shown in FIG. 2B) for preventing the movement of horizontal wheel 170 when solar panel cleaning mechanism 162 enters the secure area side. Thus at half the height, wind gusts will not be able to lift vertical wheel 172 out of bay portion 166 due to the presence of the mechanical limiter. The bay portion which is used to prevent further movement of solar panel cleaning mechanism 162 does not necessarily need to be positioned to prevent further movement of vertical wheel 172. The bay portion can be located in other positions as well in the secure area side of the securing device to prevent movement of other part(s) of solar panel cleaning mechanism 162. For example the bay portion may be located in profile 167 to stop movement of horizontal wheel 170, or in other positions in the secure area side for stopping movement of the chassis (not shown) of solar panel cleaning mechanism 162.

With reference to FIG. 2C, solar panel cleaning mechanism 162 is shown in the secure area side of barrier 168. Once properly positioned in bay portion 166, spring 174 returns to its expanded position positioning barrier 168 such that its distal end 180 holds vertical wheel 172 in place. As shown, vertical wheel 172 includes a plurality of teeth 178. As described above, when vertical wheel 172 rotates in the direction of an arrow 177, plurality of teeth 178 will grip distal end 180, enabling vertical wheel 172 to exit the secure area side of barrier 168. However, as long as vertical wheel 172 is not actively rotated by a motor, barrier 168 will keep vertical wheel 172 within securing device 164. Vertical wheel 172 needs an abrasive outer surface of sorts that will cause friction between vertical wheel 172 and barrier 168. In the embodiment shown in

FIGS. 2A-2C, the abrasive outer surface is achieved by plurality of teeth 178. However other embodiments are possible that do not require teeth. In such embodiments, the outer surface of vertical wheel 172 must be abrasive enough to cause sufficient friction with barrier 168 to grip it and cause it to rotate towards solar panel 163 when vertical wheel 172 is actively rotated by a motor (not shown).

In FIGS. 2A, 2B and 2C, a single securing device 164 is shown. According to the disclosed technique, it is also possible to use a plurality of securing devices (not shown) for securing a solar panel cleaning mechanism in a docking station. For example, if the docking station is located at the end of a solar panel row, then two securing devices may be used, one for an upper side of the cleaning mechanism and another for a lower side of the cleaning mechanism. In another example, if the docking station is located in the middle of a solar panel row, for example, either between solar panels on a solar tracker row or between two adjacent solar panels on a fixed angle solar panel row, then four securing devices may be each, two for the upper side of the cleaning mechanism and another two for the lower side of the cleaning mechanism. Each two securing devices on a given side of the cleaning mechanism thus preventing the cleaning mechanism from moving in either direction (i.e., in opposing directions).

In general, according to the disclosed technique, the barrier (such as barrier 168) is positioned within the securing device along the same axis where the motorized wheel(s) of the solar panel cleaning mechanism is positioned. Thus as shown in FIGS. 2A-2C, barrier 168 is positioned along the same axis as vertical wheel 172. However the barrier could have positioned along the same axis as the horizontal wheel if horizontal wheel 170 were motorized.

Reference is now made to FIG. 3, which is a schematic side view illustration of a mechanical limiter for preventing a solar panel cleaning mechanism from exiting a securing device due to wind gusts, generally referenced 240, constructed and operative in accordance with a further embodiment of the disclosed technique. Shown is a portion of a docking station 242, located next to a solar panel (not shown) as well as a solar panel cleaning mechanism 244, which includes a vertical wheel 250 and a horizontal wheel 248. Vertical wheel 250 is positioned in the secure area side (not labeled) of a securing device (not labeled), and is shown within a bay portion 246. As described above, both bay portion 246 and a barrier (not shown) substantially prevent vertical wheel 250 from exiting the securing device. However, strong wind gusts over a solar panel field in the direction of an arrow 252 can lift solar panel cleaning mechanism 244 in the same direction. If the wind gusts are strong enough, then not only will horizontal wheel 248 be lifted in the direction of arrow 252 however vertical wheel 250 may also be lifted in the same direction, substantially lifting vertical wheel 250 over the barrier and freeing solar panel cleaning mechanism 244 from the securing device without any active movement of vertical wheel 250. Since solar panel fields can stretch for significant distances and might be specifically positioned in open areas where high winds can be present, the possibility exists of wind gusts that are strong enough to lift vertical wheel 250 in the direction of arrow 252 high enough to free vertical wheel 250 from the securing device.

According to the disclosed technique, such unplanned releases of vertical wheel 250 from the securing device can be avoided by the use of a mechanical limiter, embodied in FIG. 3 as a limiter flange 256 which extends over a portion of horizontal wheel 248. The length of limiter flange 256 is sufficiently such that if horizontal wheel 248 begins to move in the direction of arrow 252, limiter flange 256 prevents horizontal wheel 248 from moving further upwards. Limiter flange 256 thus also prevents solar panel cleaning mechanism 244 from exiting the securing device passively by preventing vertical wheel 250 from moving or jumping upwards due to the limited movement horizontal wheel 248 can move upwards. Without the restricted movement enabled by limiter flange 256, an upward movement of horizontal wheel 248 might allow the passive force created by wind to rotate vertical wheel 250 over the barrier. It is noted that limiter flange 256 can be positioned over other portions of solar panel cleaning mechanism 244 for preventing vertical wheel 250 from jumping over the barrier due to high winds and does not need to be positioned over horizontal wheel 248 (as shown in FIG. 3). In general, in one embodiment the mechanical limiter should be positioned close to either one of vertical wheel 250 or horizontal wheel 248. It is noted that limiter flange 256 can be made from plastic or from metal. As shown, limiter flange 256 is shaped as a U-profile however other shapes of the mechanical limiter are possible.

Reference is now made to FIG. 4, which is a schematic side view illustration of a barrier of a securing device at different end positions, generally referenced 280, constructed and operative in accordance with another embodiment of the disclosed technique. FIG. 4 shows a barrier 282, including a spring 284, with a vertical wheel 290 driving over barrier 282 and substantially making barrier 282 flush with the upper surface of a solar panel 283 and folding barrier 282 into the profile (not labeled) of the solar panel. Such a setup was shown above in FIGS. 1A-1H and 2A-2C. However according to the disclosed technique barrier 282 does not need to rotate all the way such that it is flush with the upper surface of solar panel 283. Shown in FIG. 4 are two other possible end positions for barrier 282. Regardless of the end position, barrier 282 will return to the same start position (not shown in FIG. 4 but shown in FIG. 2C). However as shown in FIG. 4, from the start position, the barrier does not need to rotate all the way into the profile of the solar panel and can only rotate partly into the profile of the solar panel while nonetheless allowing vertical wheel 290 to enter the secure area side of the securing device. In a first end position 286, barrier 282 does not rotate all the way such that it is flush with the upper surface of solar panel 283 and in a second end position 288, barrier 282 rotates even less than in first end position 286. In each of these alternative end positions, the motor (not shown) of vertical wheel 290 is strong enough to move the vertical wheel over barrier 282 into the securing device and also to move vertical wheel out of the securing device when actively rotated.

Reference is now made to FIG. 5A, which is a side view schematic illustration of another solar panel cleaning mechanism securing device similar to FIG. 1A which does not use a spring, generally referenced 320, constructed and operative in accordance with a further embodiment of the disclosed technique. FIG. 5A shows a securing device similar to FIG. 1A and thus identical reference numbers are used for identical parts between FIGS. 1A and 5A. As shown, securing device 320 does not include a spring. In place of a spring, reference portion 104 includes a weight 322, which naturally pulls reference portion 104 towards stop 110. Thus barrier portion 102 and reference portion 104 will move towards platform 130 as wheel 120 rolls over barrier portion 102. However unlike FIG. 1A, a spring is not required to return barrier portion 102 to its original positon when no pressure is placed upon it by wheel 120. Barrier portion 102 returns to its original position due to the presence of weight 322 which pulls reference portion 104 towards stop 110. In FIG. 5A, weight 322 is shown as a rectangular weight as an example. However according to the disclosed technique, reference portion 104 can be shaped in any way such that the center of mass of barrier portion 102 and reference portion 104 is within reference portion 104, thus causing barrier portion 102 to rotate upwards in a clockwise direction if no force is being placed upon it. In FIG. 5A this was shown by the addition of a weight to reference portion 104, however other embodiments of this are possible.

Reference is now made to FIG. 5B, which is a side view schematic illustration of a further solar panel cleaning mechanism securing device similar to FIG. 1A which also does not use a spring, generally referenced 330, constructed and operative in accordance with another embodiment of the disclosed technique. FIG. 5B shows a securing device similar to FIG. 1A and thus identical reference numbers are used for identical parts between FIGS. 1A and 5B. As shown, securing device 330 does not include a spring. In place of a spring, a plurality of magnets 332, 334, 336 and 338 are used. As shown, two magnets 332 and 334 are positioned on platform 130, with magnet 332 being positioned on top of platform 130 and magnet 334 being positioned below platform 130. Two other magnets 336 and 338 are respectively positioned on the underside of barrier portion 102 and the upper side of reference portion 104. Magnets 332 and 336 and magnets 334 and 338 are positioned such that their facing poles repel one another (thus North-North or South-South), shown by respective arrows 340 and 342. The repelling force magnetically pushes barrier portion 102 in the direction of an arrow 344 and reference portion 104 in the direction of an arrow 346. Thus by using magnets, barrier portion 102 can have a restorative position in which it will prevent wheel 120 from exiting secure area side 132 while nonetheless letting wheel 120 rolls over barrier portion 102 as it enters the securing device.

Reference is now made to FIG. 5C, which is a side view schematic illustration of another solar panel cleaning mechanism securing device similar to FIG. 1A which does not use a stopper, generally referenced 370, constructed and operative in accordance with a further embodiment of the disclosed technique. FIG. 5C shows a securing device similar to FIG. 1A and thus identical reference numbers are used for identical parts between FIGS. 1A and 5C. As shown, securing device 370 does not include a stopper. In place of a stopper, a hinge portion 374 has been extended. The securing device with barrier portion 102 and reference portion 104 is shown in a rotated position 372, shown using dashed lines. Since hinge portion 374 was extended, it is larger than the size of the gap (not labeled) between secure area side 132 and solar panel side 134, thus as the securing device rotates towards platform 130, as shown in rotated position 372, the end of hinge portion 374 will be prevented from rotating further due to the impinging of the end of hinge portion 374 with platform 130, as shown by an arrow 376. Thus barrier portion 104 can be prevented from over-rotation without requiring a stopper by simply changing the shape of the hinge portion.

It will be appreciated by persons skilled in the art that the disclosed technique is not limited to what has been particularly shown and described hereinabove. Rather the scope of the disclosed technique is defined only by the claims, which follow.

1. A passive securing device for a solar panel service vehicle, said solar panel service vehicle comprising at least one motorized wheel having an abrasive surface, for securing said solar panel service vehicle moving over a platform into a predetermined area comprising:
a barrier portion, configured to move between a near edge position and a far edge position relative to said platform;
a restorative element, coupled with said barrier portion, having a relaxed position and a compressed position, wherein in said relaxed position said barrier portion is in said far edge position and wherein in said compressed position said barrier portion is in said near edge position, said restorative element being in said relaxed position when no external force is applied to it; and
a mechanical limiter, for preventing upwards movement of said solar panel service vehicle from said platform when said solar panel service vehicle is in said predetermined area,
wherein said barrier portion in said far edge position prevents said solar panel service vehicle from passively exiting said predetermined area;
wherein when said at least one motorized wheel is actively rotated into said barrier portion, said abrasive surface forces said restorative element into said compressed position, thereby causing said barrier portion into said near edge position and enabling said solar panel service vehicle to leave said predetermined area; and
wherein in said far edge position, a distal end of said barrier portion engaging with said at least one motorized wheel of said solar panel service vehicle is raised to a height not greater than ⅗ of a diameter of said at least one motorized wheel.

2. The passive securing device according to claim 1, wherein said solar panel service vehicle is selected from the list consisting of:
a solar panel cleaning mechanism;
a solar panel cleaning robot;
a solar panel cleaning vehicle;
a solar panel vehicle for testing and verifying solar panels;
a solar panel vehicle for swapping defective solar panels with new solar panels;
at least one second solar panel vehicle positioned on a first solar panel vehicle for transporting said at least one second solar panel vehicle from one solar row to another solar row; and
a solar panel vehicle for testing the performance of solar panels.

3. The passive securing device according to claim 1, wherein said abrasive surface comprises at least one of:
a plurality of teeth; and
a flexible material.

4. The passive securing device according to claim 1, wherein said abrasive surface causes sufficient friction between said barrier portion and said at least one motorized wheel when said at least one motorized wheel is rotated into said barrier portion, such that said abrasive surface causes said barrier portion to move to said near edge position.

5. The passive securing device according to claim 1, wherein said predetermined area is selected from the list consisting of:
a docking station;
a docking port;
a resting position over a solar panel row; and
a docking bay.

6. The passive securing device according to claim 1, wherein said platform is selected from the list consisting of:
a profile; and
a surface.

7. The passive securing device according to claim 1, wherein said platform is made from a material selected from the list consisting of:
metal; and
plastic.

8. The passive securing device according to claim 1, wherein said barrier portion is positioned over said platform in said predetermined area and only rotates above an upper surface of said platform.

9. The passive securing device according to claim 1, wherein said barrier portion comprises:
an upper portion;
a lower portion; and
a hinge, coupling said upper portion with said lower portion,
wherein said hinge is positioned below said platform;
wherein said upper portion only rotates above said platform; and
wherein said lower portion only rotates below said platform.

10. The passive securing device according to claim 1, wherein said restorative element is selected from the list consisting of:
a spring;
a mechanical coiled spring;
a push spring;
a torsion spring;
a shape memory elastic module;
a weight positioned on a lower portion of said barrier portion;
at least two magnets positioned such that respective facing poles of each one of said at least two magnets repel one another.

11. The passive securing device according to claim 1, wherein said mechanical limiter is made from a material selected from the list consisting of:
metal; and
plastic.

12. The passive securing device according to claim 1, further comprising a stop, for preventing rotation of said barrier portion beyond a predetermined point.

13. The passive securing device according to claim 1, further comprising a bay portion, positioned after said barrier, for preventing said solar panel service vehicle from moving out of said predetermined area in a distal direction from said barrier.

14. The passive securing device according to claim 1, further comprising at least one second barrier portion and at least one second respective restorative element, for preventing said solar panel service vehicle from passively exiting said predetermined area in two opposing directions.
